(19) United States
(12) Patent Application Publication
(10) Pub. No.: US 2014/0140186 A1
(43) Pub. Date: May 22, 2014

(54) CIRCUIT BOARD WITH LOW SIGNAL FAR END CROSSTALK

(71) Applicant: HON HAI PRECISION INDUSTRY CO., LTD., New Taipei (TW)

(72) Inventor: YU-HSU LIN, Santa Clara, CA (US)

(73) Assignee: HON HAI PRECISION INDUSTRY CO., LTD., New Taipei (TW)

(21) Appl. No.: 13/972,890

(22) Filed: Aug. 21, 2013

(30) Foreign Application Priority Data
Nov. 21, 2012 (CN) 2012104746708

(51) Int. Cl. H04B 3/32

(52) U.S. Cl. CPC H04B 3/32
USPC 370/201

(57) ABSTRACT

A circuit board includes at least four signal lines. The at least four signal lines are substantially parallel to each other and includes two first adjacent signal lines and two second adjacent signal lines adjacent to the first adjacent signal lines. A polarity of signals transmitted by the two first adjacent signal lines is opposite to a polarity of signals transmitted by two second adjacent signal lines.

### BACKGROUND

1. Technical Field

The present disclosure relates to circuit boards, and particularly to a circuit board with low signal far end crosstalk (FEXT).

2. Description of Related Art

A plurality of signal lines are arranged on a circuit board to offer a high speed signal for the circuit board. However, FEXT may occur among the high speed signal transmitted by the plurality of signal lines. The circuit board cannot work well with high FEXT. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a circuit board in accordance with a first embodiment.

FIG. 2 is a schematic view of the circuit board in accordance with a first embodiment.

FIG. 3 is a schematic view of the circuit board in accordance with a first embodiment.

FIG. 4 is a schematic view of the circuit board in accordance with a first embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

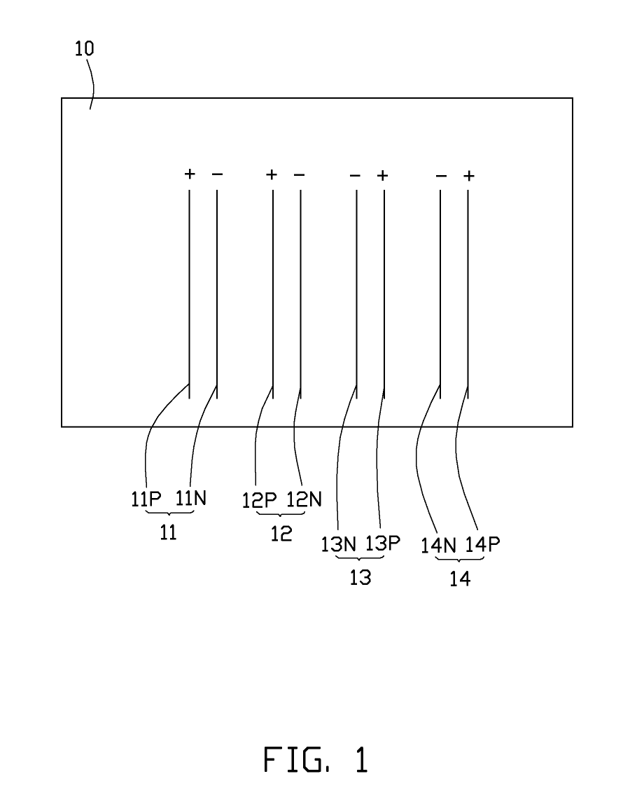

FIG. 1 illustrates a first circuit board 10 in accordance with a first embodiment. The first circuit board 10 comprises a plurality of parallel differential pairs. In one embodiment, the plurality of parallel differential pairs comprises a first differential pair 11, a second differential pair 12, a third differential pair 13, and a fourth differential pair 14. The first differential pair 11, the second differential pair 12, the third differential pair 13, and the fourth differential pair 14 are arranged in proper sequence. That is, the second differential pair 12 is arranged at the right side of the first differential pair 11, the third differential pair 13 is arranged at the right side of the second differential pair 12, and the fourth differential pair 14 is arranged at the right side of the third differential pair 13.

The first differential pair 11 comprises a first positive differential signal line 11P and a first negative differential signal line 11N. The second differential pair 12 comprises a second positive differential signal line 12P and a second negative differential signal line 12N. The third differential pair 13 comprises a third positive differential signal line 13P and a third negative differential signal line 13N. The fourth differential pair 14 comprises a fourth positive differential signal line 14P and a fourth negative differential signal line 14N.

In the first differential pair 11, the first negative differential signal line 11N is arranged at the right side of the first positive differential signal line 11P. In the second differential pair 12, the second negative differential signal line 12N is arranged at the right side of the second positive differential signal line 12P. In the third differential pair 13, the third negative differential signal line 13N is arranged at the left side of the third positive differential signal line 13P. In the fourth differential pair 14, the fourth negative differential signal line 14N is arranged at the left side of the fourth positive differential signal line 14P.

An arrangement sequence of two differential signal lines (comprising the third positive differential signal line 13P and the third negative differential signal line 13N) in the third differential pair 13 is the same as an arrangement sequence of two differential signal lines (comprising the fourth positive differential signal line 14P and the fourth negative differential signal line 14N) in the fourth differential pair 14, but opposite to an arrangement sequence of two differential signal lines (comprising the first positive differential signal line 11P and the first negative differential signal line 11N) in the first differential pair 11. The arrangement sequence of two differential signal lines in the first differential pair 11 is the same as an arrangement sequence of two differential signal lines (comprising the second positive differential signal line 12P and the second negative differential signal line 12N) in the second differential pair 12. Therefore, a polarity of signals transmitted by the third differential pair 13 and the fourth differential pair 14 is opposite to a polarity of signals transmitted by the first differential pair 11 and the second differential pair 12. When the first differential pair 11, the second differential pair 12, the third differential pair 13, and the fourth differential pair 14 are transmitting signals, some signal FEXT of the first circuit board 10 is canceled, and the signal FEXT of the first circuit board 10 can be decreased.

In testing, when the arrangement sequence of the two differential signal lines in the first differential pair 11 is the same arrangement sequence as the two differential signal lines in the second differential pair 12, and the arrangement sequence of the two differential signal lines in the third differential pair 13 is the same arrangement sequence as the two differential signal lines in the fourth differential pair 14, the signal FEXT of the first circuit board 10 reached 8.3 percent. When the plurality of differential signal lines of the first circuit board 10 are arranged as the first differential pair 11, the second the differential pair 12, the third differential pair 13, and the differential pair 14 shown in FIG. 1, the signal FEXT of the first circuit board 10 is decreased to 0.2 percent.

In the embodiment, the plurality of differential pairs may comprise more than four differential pairs. The arrangement sequence of every two differential signal lines of two first differential pairs is opposite to the arrangement sequence of every two differential signal lines of two second differential pairs that is adjacent to the two first differential pairs, thus the signal FEXT of the first circuit board 10 can be decreased. For example, the arrangement sequence of the plurality of differential pairs can be [+, −], [+, −], [−, +], [−, +], [+, −], [+, −], [−, +], [−, +] . . . (+ is the positive differential signal line, and − is the negative differential signal line).

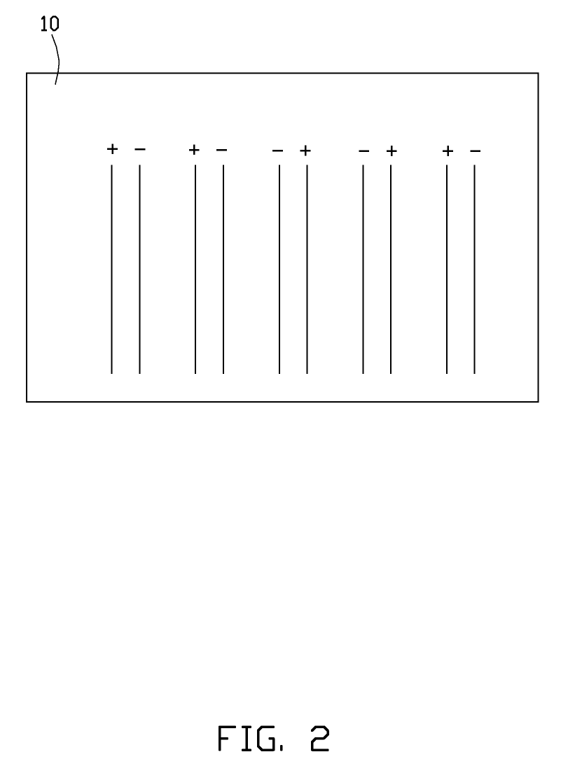

FIG. 2 illustrates a circuit board with five differential pairs. The number of the plurality of differential pairs is odd number. For example, the plurality of differential pairs comprise five differential pairs. The arrangement sequence of the five differential pairs is [+, −], [+, −], [−, +], [−, +], [+, −] (+ is the positive differential signal line, and − is the negative differential signal line), and the signal FEXT of the first circuit board 10 can be decreased.

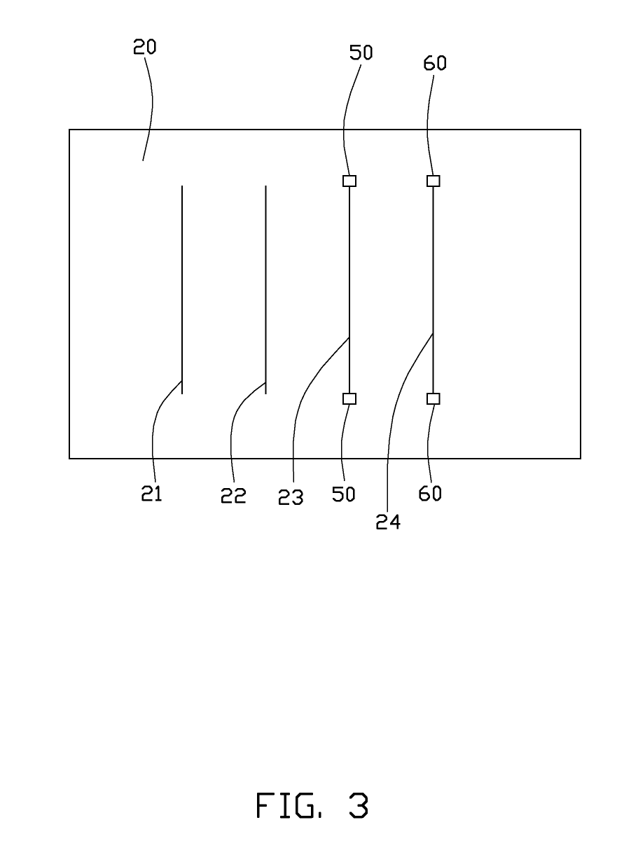

FIG. 3 illustrates a second circuit board 20 in accordance with a second embodiment. A plurality of single-ended signal lines is arranged on a second circuit board 20. The plurality of single-ended signal lines are substantially parallel to each other, and comprises a first single-ended signal line 21, a second single-ended signal line 22, a third single-ended signal line 23, and a fourth single-ended signal line 24.

The first single-ended signal line 21, the second single-ended signal line 22, the third single-ended signal line 23, and the fourth single-ended signal line 24 are arranged in proper sequence. That is, the second single-ended signal line 22 is arranged at the right side of the first single-ended signal line 21, the third single-ended signal line 23 is arranged at the right side of the second single-ended signal line 22, and the fourth single-ended signal line 24 is arranged at the right side of the third single-ended signal line 23.

Two first reversers 50 are connected to opposite ends of the third single-ended signal line 23, and two second reversers 60 are connected to opposite ends of the fourth single-ended signal line 24. A positive polarity of signal, before transmitted by the third single-ended signal line 23, is changed to a negative polarity of signal; and the negative polarity of signal, after transmitted by the third single-ended signal line 23 is changed back to the positive polarity of signal. Similarly, a positive polarity of signal, before transmitted by the fourth single-ended signal line 24, is changed to a negative polarity of signal; and the negative polarity of signal, after transmitted by the fourth single-ended signal line 24 is changed back to the positive polarity of signal. A polarity of signals transmitted by the first single-ended signal line 21 and the second single-ended signal line 22 are always positive, some signal FEXT of the second circuit board 20 is canceled, and the signal FEXT of the second circuit board 20 can be decreased.

In testing, when a polarity of signals transmitted by the first single-ended signal line 21, the second single-ended signal line 22, the third single-ended signal line 23, and the fourth single-ended signal line 24 is always positive, the signal FEXT of the second circuit board 20 reached 38 percent. When the two first reversers 50 are connected to the third single-ended signal line 23 and the two second reversers 60 are connected to the fourth single-ended signal line 24 in FIG. 3, a polarity of signals transmitted by the first single-ended signal line 21, the second single-ended signal line 22 is positive, and a polarity of signals transmitted by the third single-ended signal line 23 and the fourth single-ended signal line 24 is negative, the signal FEXT of the second circuit board 20 is decreased to 3 percent.

In the embodiment, the plurality of single-ended signal lines may comprise more than four single-ended signal lines. The polarity of signals transmitted by two first single-ended signal lines of the more than four single-ended signal lines is opposite to polarity of signals transmitted by two second single-ended signal lines that is adjacent to the two first single-ended signal lines, the signal FEXT of the second circuit board 20 can be decreased. For example, the polarities of signals transmitted by the more than four single-ended signal lines is [+], [+], [−], [−], [+], [+], [−], [−] . . . (+ is the positive polarity, and − is the negative polarity).

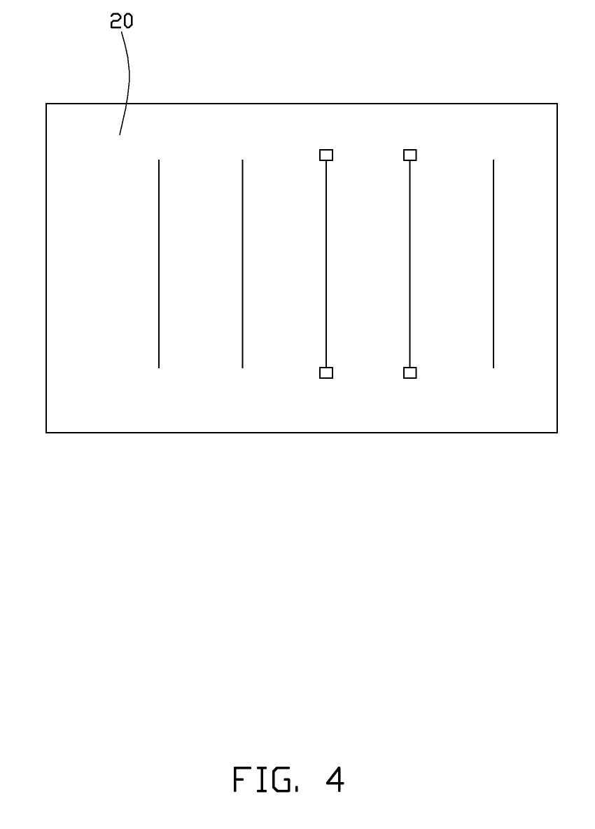

FIG. 4 illustrates the second circuit board 20 with five single-ended signal lines. The number of the plurality of single-ended signal lines is an odd number. For example, the plurality of single-ended signal lines comprise five single-ended signal lines. The polarity of signals transmitted by the five single-ended signal lines is [+], [+], [−], [−], [+] (+ is the positive polarity, and − is the negative polarity).

Therefore, when a plurality of parallel signal lines (comprising the plurality of parallel differential pairs and the plurality of single-ended signal lines) are transmitting signals, the polarity of signals transmitted by two first adjacent signal lines of the plurality of signal lines is opposite to the polarity of signals transmitted by two second adjacent signal lines that is adjacent to the two first adjacent signal lines, the signal FEXT of the circuit board (comprising the first circuit board 10 and the second circuit board 20) can be decreased.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A circuit board comprising:
at least four signal lines; the at least four signal lines being substantially parallel to each other and comprising two first adjacent signal lines and two second adjacent signal lines, and the two second adjacent signal lines being adjacent to the first adjacent signal lines;
wherein two polarities of signals transmitted by the two first adjacent signal lines are opposite to two polarities of signals transmitted by two second adjacent signal lines.

2. The circuit board of claim 1, wherein the at least four signal lines comprises two first differential pairs and two second differential pairs adjacent to the first differential pairs; each first differential pair comprises a first positive differential signal line and a first negative differential signal line; each second differential pair comprises a second positive differential signal line and a second negative differential signal line; and an arrangement sequence of the first positive differential signal line and the second negative differential signal line is opposite to an arrangement sequence of the second positive differential signal line and the second negative differential signal line.

3. The circuit board of claim 2, wherein the two second differential pairs are arranged at a lateral side of the two first differential pairs.

4. The circuit board of claim 3, wherein the first positive differential signal line is arranged at a left side of the first negative differential signal line, and the second positive differential signal line is arranged at a right side of the second negative differential signal line.

5. The circuit board of claim 1, wherein the at least four signal lines comprises two first single-ended signal lines and two second single-ended signal lines adjacent to the first single-ended signal lines; and a polarity of signals transmitted by the two first single-ended signal lines is opposite to a polarity of signals transmitted by two second single-ended signal lines.

6. The circuit board of claim 5, wherein the polarity of signals transmitted by the two first single-ended signal lines is negative, and the polarity of signals transmitted by the two second single-ended signal lines is positive.

7. The circuit board of claim 5, wherein the two single-ended signal lines are arranged at the lateral side of the two second single-ended signal lines.

8. The circuit board of claim 7, wherein two reversers are connected to opposite ends of each second single-ended signal lines.

9. A circuit board comprising:
at least four signal lines being substantially parallel to each other and comprising two first adjacent signal lines and two second adjacent signal lines;
wherein two polarities of signals transmitted by the two first adjacent signal lines are opposite to two polarities of signals transmitted by two second adjacent signal lines.

10. The circuit board of claim 9, wherein the at least four signal lines comprises two first differential pairs and two second differential pairs adjacent to the first differential pairs; each first differential pair comprises a first positive differential signal line and a first negative differential signal line; each second differential pair comprises a second positive differential signal line and a second negative differential signal line; and an arrangement sequence of the first positive differential signal line and the second negative differential signal line is opposite to an arrangement sequence of the second positive differential signal line and the second negative differential signal line.

11. The circuit board of claim 10, wherein the two second differential pairs are arranged at a lateral side of the two first differential pairs.

12. The circuit board of claim 11, wherein the first positive differential signal line is arranged at a left side of the first negative differential signal line, and the second positive differential signal line is arranged at a right side of the second negative differential signal line.

13. The circuit board of claim 9, wherein the at least four signal lines comprises two first single-ended signal lines and two second single-ended signal lines adjacent to the first single-ended signal lines; and a polarity of signals transmitted by the two first single-ended signal lines is opposite to a polarity of signals transmitted by two second single-ended signal lines.

14. The circuit board of claim 13, wherein the polarity of signals transmitted by the two first single-ended signal lines is negative, and the polarity of signals transmitted by the two second single-ended signal lines is positive.

15. The circuit board of claim 14, wherein the two single-ended signal lines are arranged at the lateral side of the two second single-ended signal lines.

16. The circuit board of claim 15, wherein two reversers are connected to opposite ends of each second single-ended signal lines.
